(19) United States
(12) Patent Application Publication
(10) Pub. No.: US 2014/0039687 A1
(43) Pub. Date: Feb. 6, 2014

(54) FIELD CUSTOM FREQUENCY SKIPPING

(71) Applicant: CARRIER CORPORATION, Farmington, CT (US)

(72) Inventors: Kevin Mercer, Danville, IN (US); Dale R. Bennett, Indianapolis, IN (US); Robert C. Swilik, Indianapolis, IN (US)

(73) Assignee: CARRIER CORPORATION, Farmington, CT (US)

(21) Appl. No.: 13/956,836

(22) Filed: Aug. 1, 2013

Related U.S. Application Data
(60) Provisional application No. 61/678,392, filed on Aug. 1, 2012.

(51) Int. Cl. G05D 23/19; F24H 9/20

(52) U.S. Cl. CPC G05D 23/19; F24H 9/2064
USPC 700/276; 165/11.2; 62/127; 62/129; 165/200

(57) ABSTRACT

A method, system, and control system for operating a HVAC system having one or more variable-speed components is provided. The method includes running the one or more variable-speed components at a first setpoint, and determining that the first setpoint generates a response having an intensity above a threshold. The response includes a vibration, a noise, or a combination thereof. The method further includes logging the first setpoint into a list of setpoints to avoid. The method also includes, in response to determining that the first setpoint generates the response having the intensity above the threshold, adjusting the one or more variable-speed components to a second setpoint.

### CROSS-REFERENCE TO RELATED APPLICATION

This application claims priority to U.S. Provisional Patent Application Ser. No. 61/678,392, filed on Aug. 1, 2012, which is incorporated herein by reference in its entirety.

### BACKGROUND

In conventional HVAC systems, the driven mechanical components thereof (e.g., fans, blowers, compressors) each generally run at a single speed or “setpoint.” Thus the system operates with the components either powered on, operating at the setpoint or accelerating up to it, or powered off, at rest or coasting down from the setpoint. As such, the temperature of a facility is generally regulated by turning on and off the HVAC system, such that the temperature oscillates around a desired temperature.

Recently, systems employing variable-speed mechanical components have been employed for increased efficiency. The speed of the components can be modulated, such that the HVAC systems operate continuously at a setpoint chosen to maintain a desired temperature in the facility, obviating the on/off cycling that is characteristic of traditional systems. The heat transfer characteristics of the facility are typically not static, however, as occupancy, rate of ingress/egress, and/or ambient conditions may vary by time. Thus, the variable-speed systems operate using a feedback loop, such that the system can move across a range of setpoints to maintain the desired temperature in the facility.

Operating across a range of compressor speeds, fan speeds, blower speeds, etc., however, results in vibration and/or noise responses in the HVAC system across a range of frequencies. Such vibrations generated by these moving parts may propagate in the ducts, pipes, casings, etc. of the system and may result in resonance conditions. Resonance conditions often result in the high-amplitude vibrations, which can generate high-intensity noise. Further, noise can be generated as air, moved at a particular rate, moves through a diffuser. In either case, such noise may reach unacceptable levels (e.g., in commercial or residential settings).

Generally, system designers seek to avoid such vibration and/or noise by testing the HVAC systems in laboratories or other controlled settings. While these tests may establish the loci of certain undesired setpoints, such controlled conditions may not fully account for all variables present when the HVAC systems are installed in the field. For example, different types of duct work (e.g., ducts, supports, etc.) may be called for in different locations or favored by different installers. Moreover, different buildings may require different lengths or different combinations of ducts, thereby altering the resonance characteristics of the ducts. Further, the vibration characteristics of the HVAC system may change over time, as the various components thereof expand or wear, connections loosen, etc. Thus, the setpoints identified as causing offensive vibration and/or noise in the test lab may only account for a portion of the setpoints that should be avoided and, further, the set of setpoints to be avoided may evolve over time.

What is needed, then, are systems and methods for operating HVAC systems having variable-speed components, which enable avoiding setpoints that result in high-intensity vibration and/or noise responses.

### SUMMARY

Embodiments of the disclosure may provide a method for operating a HVAC system having one or more variable-speed components. The method includes running the one or more variable-speed components at a first setpoint, and determining that the first setpoint generates a response having an intensity above a threshold. The response includes a vibration, a noise, or a combination thereof. The method further includes logging the first setpoint into a list of setpoints to avoid. The method also includes, in response to determining that the first setpoint generates the response having the intensity above the threshold, adjusting the one or more variable-speed components to a second setpoint.

Embodiments of the disclosure may also provide a control system for an HVAC system. The control system includes a panel including an input device configured to register a setpoint objection from a user. The HVAC system includes one or more variable-speed components, with the one or more variable-speed components being operable at a plurality of setpoints. The control system also includes a controller configured to communicate with the panel and at least one of the one or more variable-speed components. The controller is configured to receive an indication of the setpoint objection from the panel and, in response, adjust a speed of at least one of the one or more variable-speed components.

Embodiments of the disclosure may further provide a system including a processing system including a processor, and a memory system including one or more computer-readable media. The one or more computer-readable media contain instructions that, when executed by the processing system, cause the system to perform operations. The operations include running the one or more variable-speed components at a first setpoint, and determining that the first setpoint generates a response having an intensity above a threshold. The response includes a vibration, a noise, or a combination thereof. The operations also include logging the first setpoint into a list of setpoints to avoid, and, in response to determining that the first setpoint generates the response having the intensity above the threshold, adjusting the one or more variable-speed components to a second setpoint.

### BRIEF DESCRIPTION OF THE DRAWINGS

The accompanying drawings, which are incorporated in and constitute a part of this specification, illustrate aspects of the present teachings and together with the description, serve to explain principles of the present teachings. In the figures:

FIG. 1 illustrates a schematic view of an HVAC system, according to an embodiment.

FIG. 2 illustrates a schematic view of a controller for the HVAC system, according to an embodiment.

FIG. 3 illustrates a flowchart of a method for operating an HVAC system having a range of setpoints, according to an embodiment.

FIG. 4 illustrates a flowchart of a method for scanning the range of setpoints for high-intensity vibration conditions, according to an embodiment.

### DETAILED DESCRIPTION

Reference will now be made in detail to various embodiments of the present teachings, an example of which is illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific implementations of the invention that may be practiced. These implementations are described in sufficient detail to enable those skilled in the art to practice these implementations and it is to be understood that other implementations may be utilized and that changes may be made without departing from the scope of the present teachings. The following description is, therefore, merely exemplary.

In general, the present disclosure relates to systems and methods for controlling an HVAC system of any type (e.g., gas, oil, or electric furnace, boiler, heat pump, air conditioner, etc.) having one or more variable-speed, rotary or otherwise moveable components. Such components may be or include one or more compressors, fans, blowers, combinations thereof, and/or the like. Further, such components may be fluidly, physically, or otherwise coupled together and to a facility, such that the HVAC system is configured to control the temperature of the facility. It may be advantageous to avoid certain setpoints (e.g., speeds or combinations of speeds) of the variable-speed component(s) at which the component(s) generate responses having a high intensity, such as, for example, high-amplitude vibration response at or near a resonance frequency or a harmonic thereof. Such vibration and/or noise responses may have an intensity that exceeds a threshold considered offensive to those in the facility.

The present disclosure provides one or more systems and methods for identifying such setpoints and avoiding them, for example, while the system is already and remains installed. Accordingly, the HVAC system may provide a panel or another input device, with which the user, installer, or another operator, may identify objectionable operating setpoints. Further, the HVAC system may implement a setpoint scanning process, which may test a range of setpoints and identify high-intensity response conditions in the system, such that the objectionable setpoints can be avoided during normal operation. Additionally, the HVAC system may provide for automatic objectionable setpoint detection, for example, by detecting excessive vibration and/or noise in the system using a suitable measuring device. Any combination of these elements may be provided in various embodiments described herein.

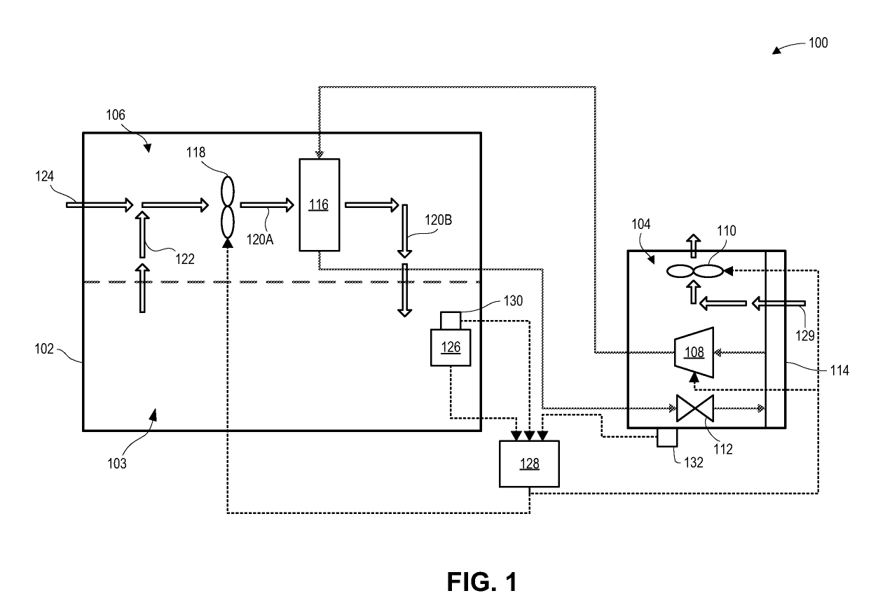

Referring now in detail to the illustrative embodiment shown in the figures, FIG. 1 depicts a simplified schematic view of an HVAC system 100, according to an embodiment. The HVAC system 100 may be configured to heat and/or cool a facility 102 and, particularly, a volume of air 103 therein. Accordingly, as illustrated, the HVAC system 100 may be installed in the field (i.e., its intended end-user destination). The illustrated HVAC system 100 is configured to heat the facility 102; however, it will be appreciated that a reversing valve or any other device may be provided to enable the HVAC system 100 to switch between heating and cooling.

The HVAC system 100 may be a “split system,” in which one or more components reside outside the facility 102, in an outside section 104, and one or more components reside inside the facility 102, in an inside section 106. The inside section 106 may be separated from the volume of air 103, for example, be part of an attic, basement, and/or the like. The outside section 104 may be disposed adjacent the facility 102, for example, in a casing. However, in other embodiments, the HVAC system 100 may not be split, but may instead reside inside the facility 102, extend partially inside and partially outside the facility 102, or be in any other configuration.

In the outside section 104, the HVAC system 100 may include a compressor 108, a fan 110, an expansion device 112, and a “first” heat exchanger 114, among other components. The compressor 108 may be any suitable type and size of compressor. For example, the compressor 108 may be one or more scroll compressors. However, in other embodiments, the compressor 108 may be a centrifugal compressor, a reciprocating compressor, an axial compressor, a screw compressor, combinations thereof, and/or the like.

Similarly, the fan 110 may be any type of air moving device, for example, a fan or blower, whether axial, radial, centrifugal, or the like, suitable for the desired application and having any suitable type and number of blades. Accordingly, use herein of the term “fan” to refer to the component labeled 110 is not to be considered limiting to any particular flow rates, compression ratios, or the like.

The first heat exchanger 114 may be a heat exchanger of any suitable type and size. For example, the first heat exchanger 114 may include one or more plate-and-fin, shell-and-tube, cross-flow, parallel-flow, or counter-flow heat exchangers, combinations thereof, and/or the like. In at least one embodiment, the first heat exchanger 114 may include one or more metallic (e.g., copper or aluminum) coils.

The expansion device 112 may be any suitable type of device configured to expand a refrigerant or other working fluid. The expansion device 112 may be, for example, a Joule-Thompson valve, but in other embodiments, may be a turbine. In some embodiments, the expansion device 112 may be located in the inside section 106, rather than in the outside section 104. In still other embodiments, the HVAC system 100 may include two expansion devices (e.g., valves), one of which, e.g., the expansion device 112, may be located in the outside section 104, while the other is located in the inside section 106. This configuration may prove advantageous in HVAC systems 100 including a reversing valve, where the HVAC system 100 is configured to toggle between cooling and heating the facility 102.

In the inside section 106, the HVAC system 100 may include a “second” heat exchanger 116 and a blower 118. The second heat exchanger 116 may be or include one or more heat exchangers of any suitable type and size. For example, the second heat exchanger 116 may include one or more plate-and-fin, shell-and-tube, cross-flow, parallel-flow, counter-flow heat exchangers, combinations thereof, and/or the like. In at least one embodiment, the second heat exchanger 116 may be or include one or more metallic coils.

The blower 118 may be any suitable type of air moving device, for example, a centrifugal, radial, or axial fan or blower having any number and size of blades. Accordingly, it will be appreciated that the use of the term “blower” to describe the component labeled 118 in FIG. 1 is not to be considered limiting to any particular flow rates or pressure ratios, as are commonly used to technically distinguish between a blower and a fan.

The compressor 108 may be fluidly coupled to the second heat exchanger 116, such that the second heat exchanger 116 receives working fluid from the compressor 108. The second heat exchanger 116 may be fluidly coupled with the expansion device 112, so as to provide the working fluid thereto. The expansion device 112 may be fluidly coupled to the first heat exchanger 114, such that the first heat exchanger 114 receives the working fluid therefrom. The first heat exchanger 114 may also be fluidly coupled to the compressor 108, and configured to provide working fluid thereto, thereby closing the loop on the working fluid portion of the HVAC system 100.

Despite the HVAC system 100 being split, the various components of the inside and outside sections 104, 106 may be harmonically or vibrationally coupled, e.g., via ducts, pipes, tubes, walls, supports, etc. Accordingly, responses forced by moveable equipment in one of the sections 104, 106 and/or air flowing through a diffuser may combine with responses in the other one of the sections, in some cases, constructively, to produce heightened vibration and/or noise responses. Further, in non-split systems, the same or similar constructive interference may be experienced.

In operation, the HVAC system 100 may provide a heat pump, according to at least one illustrative embodiment, for transferring heat from the colder environment to the warmer facility 102, for example. It will be readily appreciated, however, that the HVAC system 100 may provide or be provided as any type of thermodynamic system, such as one or more gas, oil, or electric furnaces, air conditioners, or heat pumps configured to cool the facility 102. As such, in some embodiments, one or more of the moveable components (e.g., the compressor 108, fan 110, and/or blower 118) may be omitted from the HVAC system 100. For example, a furnace embodiment of the HVAC system 100 may not require a compressor 108.

In the illustrated embodiment, however, the compressor 108 may be included and configured to compress a warm, generally gaseous working fluid and provide a warm, pressurized working fluid to the second heat exchanger 116. The working fluid may be a refrigerant (e.g., R134a, R410, Freon, another HCFC, etc.), carbon dioxide, a hydrocarbon (e.g., methane, propane, etc.), argon, nitrogen, or any other suitable working fluid.

The warmed, pressurized working fluid may course through the second heat exchanger 116. The blower 118 may motivate a stream of air 120A across the second heat exchanger 116, such that the second heat exchanger 116 acts as a condenser, transferring heat from the working fluid to the stream of air 120B and resulting in a warmed stream of air 120B and an at least partially condensed working fluid. Thereafter, the warmed stream of air 120B may be provided to the volume of air 103, so as to heat the facility 102.

The stream of air 120A may be provided by either or both of a return air stream 122 and a fresh air stream 124, with the return air stream 122 being received from the volume of air 103 and the fresh air stream 124 being received from the ambient environment. In some embodiments, the flow rate of one or both of the return air stream 122 and the fresh air stream 124 may be modulated or cut off, e.g., using a damper, to affect the flow rate of the stream of air 120A and/or a ratio of fresh air to return air. In other embodiments, one of the return air stream 122 or the fresh air stream 124 may be unnecessary and omitted.

The condensed working fluid may then pass to the expansion device 112, which may decrease the pressure of the working fluid, resulting in a cooled, low-pressure working fluid. The cooled, low-pressure working fluid may then pass to the first heat exchanger 114. The fan 110 may draw a stream of air 129 from the ambient environment across the first heat exchanger 114. Accordingly, the cooled, low-pressure working fluid may receive heat from the ambient environment, resulting in a warmed working fluid. Thus, the first heat exchanger 114 may serve as an evaporator in the HVAC system 100, tending to boil at least a portion of the working fluid into the gaseous state. The primarily gaseous working fluid may then proceed to the compressor 108, thereby restarting the cycle.

One or more of the compressor 108, fan 110, and blower 118 may be a variable-speed, movable component of the HVAC system 100, i.e., providing an example of the one or more variable-speed, moveable components mentioned above. As such, the compressor 108, fan 110, and blower 118 may each include a driver, which may be configured to operate across a range of speeds. In other embodiments, a single driver may operate two or more of the compressor 108, fan 110, and blower 118. Further, in various embodiments, one, two, or three of the compressor 108, fan 110, and blower 118 may be variable speed, while the remaining components are single-speed. However, for ease of description, an embodiment in which the compressor 108, fan 110, and blower 118 are driven independently and are operable across a range of speeds will be described herein. It will be appreciated, however, that this is but one embodiment among many contemplated. Further, the speeds, temperatures, flow rates, or any other variable of the variable-speed components may be combined to define “setpoints” of the HVAC system 100.

The HVAC system 100 may also include a control system, which may be at least partially provided by a panel 126 and a controller 128. The panel 126 may be disposed in the volume of air 103, for example, accessible to humans located in the facility 102. Further, the panel 126 may provide a thermostat and/or an input device, such as a button, switch, or the like. The input device may provide an interface for the user to register or otherwise record an objectionable setpoint. The controller 128 may be positioned at any suitable location, such as in or proximal to the outside section 104, the inside section 106, or at some other position in or near the facility 102, or remote therefrom.

The panel 126 may be communicably coupled with the controller 128, such that the panel 126 may be configured to transfer temperature data (e.g., from the thermostat) and setpoint objections (from the input device) to the controller 128. The controller 128, in turn, may be communicably coupled to the blower 118, compressor 108, and the fan 110, at least. More particularly, the controller 128 may be coupled with the drivers thereof and/or one or more components thereof configured to control the speed of the associated one of the compressor 108, fan 110, and blower 118. Accordingly, the controller 128 may be configured to control the speed of the variable speed, moveable components.

The HVAC system 100 may also include one or more sound or vibration measuring devices 130, 132 configured to detect noise or vibration in the structures of the HVAC system 100. At least one of the measuring devices 130 may be positioned in the facility 102, for example, in sensitive areas thereof (e.g., where noise would be most noticeable). Instead or in addition, at least one of the measuring devices 132 may be positioned proximal the compressor 108 and fan 110, e.g., in or near the outside section 104 of a split system embodiment of the HVAC system 100. It will be appreciated that the measuring devices 130, 132 and/or others may be disposed elsewhere in the HVAC system 100 and the two locations shown are merely illustrative of the function of the measuring devices 130, 132. Further, the measuring devices 130, 132 may be accelerometers, sound level meters or dosimeters, or any other suitable device.

In operation, the panel 126 may measure the temperature of the volume of air 103 and provide temperature feedback to the controller 128. The controller 128 may interpret the feedback and modulate the speeds of the compressor 108, fan 110, and blower 118 according to any suitable control logic. Further, the panel 126 may transmit an indication of an objectionable setpoint to the controller 128 when a user registers a setpoint objection on the input device (e.g., by pushing a button) of the panel 126. Additionally, the measuring devices 130, 132 may also provide a setpoint objection to the controller 128 when the noise or vibration in the HVAC system 100 is excessive and indicative of resonance.

The controller 128 may receive the setpoint objections and take corrective action. The corrective action may include appending a list of setpoints to be avoided in the future with the current setpoint, and adjusting the speed of one or more of the variable-speed rotary components (e.g., one or more of the compressor 108, fan 110, and blower 118). Accordingly, the controller 128 may “remember” which setpoints are to be avoided in the future when modulating speeds to provide a desired temperature in the volume of air 103 and, if an objectionable setpoint is encountered, the controller 128 may move the HVAC system 100 away from that setpoint, to reduce vibration.

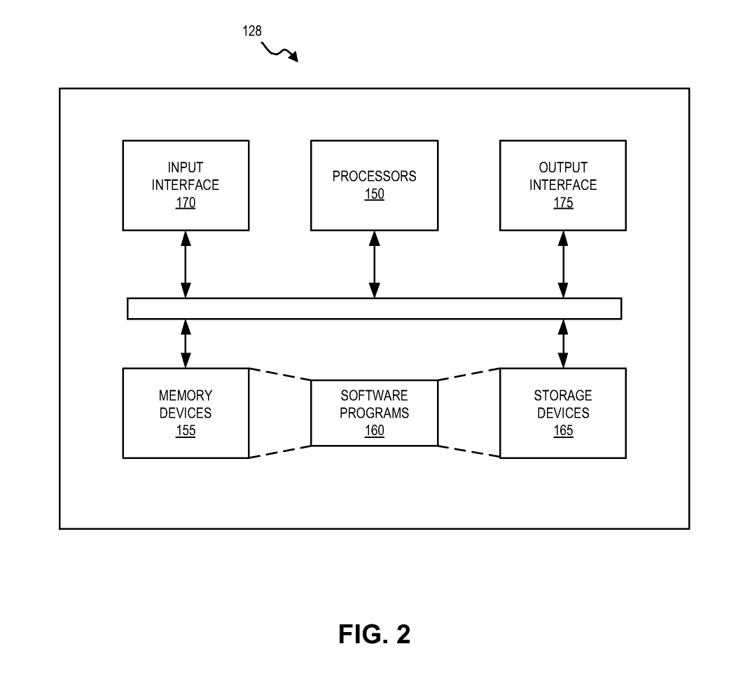

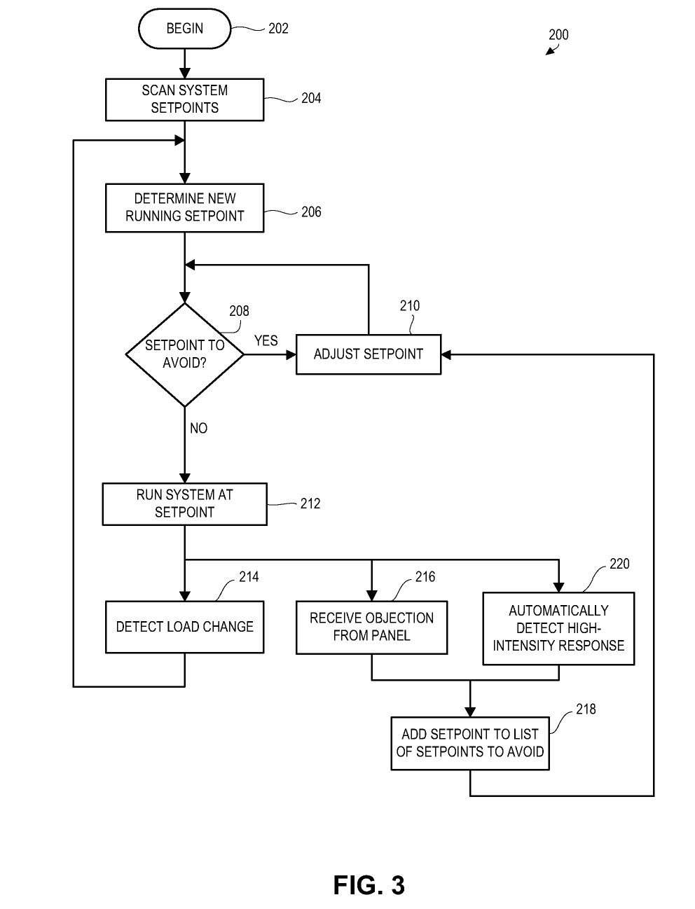

FIG. 2 illustrates a schematic view of the controller 128, according to an embodiment. The controller 128 may be any suitable type of programmable logic controller, including a general or specific-use computer. The controller 128 may thus include a processing system including one or more processors 150, and a memory system including one or more memory devices 155. The memory device 155 may include one or more computer readable media. The computer-readable medium may be or include volatile or non-volatile memory, such as RAM, flash memory, hard disks, etc. The computer-readable medium may have stored thereon one or more software programs 160. The software program 160 may include instructions that, when executed by one or more of the processors 150, are configured to cause the controller 128 to perform certain operations, for example, as will be described below with reference to the methods shown in FIGS. 3 and/or 4.

The controller 128 may also include one or more storage devices 165, which may be configured to store a list of setpoints to avoid, at the least. In some embodiments, the storage device(s) 165 may be integrated with the memory device 155. The processor 150 may be coupled to the storage device 165 so as to enable the processor 150 to access the list of setpoints to avoid. The controller 128 may also include an input interface 170 and an output interface 175. The interfaces 170, 175 may each include one or more ports, network interfaces, wireless transmitters/receivers, etc., such that the controller 128 is communicable with external devices, including, for example, the compressor 108, fan 110, blower 118, panel 126, measuring devices 130, 132, and/or others.

With continuing reference to FIGS. 1 and 2, FIG. 3 illustrates a flowchart of a method 200 for operating the variable-setpoint HVAC system 100, according to an embodiment. The method 200 may be implemented by operation of the controller 128, according to one or more embodiments thereof.

The method 200 may begin, as at 202, with one or more initial conditions set. The initial conditions for the method 200 may include the HVAC system 100 having been physically installed in the field and prepared for start-up. In some embodiments, the method 200 may proceed to a testing or “scanning” phase, as at 204, in which a plurality of setpoints across a range of operational setpoints are tested for high-intensity responses, such as noise and/or vibration. This may provide an initial population of the list of setpoints to avoid during operation. Additional details of one embodiment of such scanning are discussed below with reference to FIG. 3.

The method 200 may then proceed to “normal operation,” i.e., providing the heating or cooling the volume of air 103 in the facility 102. Accordingly, the method 200 may include determining an operational setpoint for the HVAC system 100, as at 206, using any suitable control logic. For example, the initial “start-up” operational setpoint may be configured to bring the temperature of the volume of air 103 to a desired temperature rapidly and thus, in some embodiments, may include running the HVAC system 100 at full power in a transient, start-up state. In more steady-state operation, the operational setpoint may be some value between no power and full power (inclusive), configured to maintain a generally steady temperature in the volume of air 103.

After determining the new setpoint, as at 206, the method 200 may proceed to determining if the selected setpoint is known to be a setpoint to avoid, as at 208. Such determination may proceed by the controller 128 comparing the selected setpoint to the setpoints contained in the list of setpoints to avoid. The list may be initially populated by scanning the system setpoints, as at 204; however, if scanning is omitted, the list may initially be empty.

If the controller 128 determines that the setpoint is already contained in the list of objectionable setpoints, the method 200 may proceed to the controller 128 adjusting the setpoint, as at 210. Adjusting the setpoint may proceed according to any suitable logic so as to alter the speed of any of the variable-speed components. For example, adjusting the fan 110 may, in some instances, have less impact on HVAC system 100 efficiency than adjusting the compressor 108. In other situations, adjusting the compressor 108 may provide greater vibration reduction. A variety of such responses may be considered by the controller 128 when making the setpoint adjustments, to arrive at the least disruption of the system performance, while still reducing vibration intensity or amplitude. Further, the adjustment may be relatively minor, for example, about 5% increase or decrease in the speed of one or more of the moveable components may provide move the overall system setpoint my a sufficient amount.

In some embodiments, adjusting the speed may be performed by altering the flowpath area for the streams of air 122, 124, 129 proceeding to or from one of the blower 118 and the fan 110. For example, the flowpath may be constricted to increase the load on the blower 118 or fan 110, which may slightly alter the speed of thereof. Such constriction may be provided by a variable position damper, which may be set to obstruct the flowpath to a varying degree.

After adjusting the setpoint 210, whether before or after implementing either the original or the adjusted setpoint, the controller 128 may proceed to checking if the adjusted setpoint is in the list of setpoints to avoid. This may ensure that the adjusted setpoint has not also been identified as being an objectionable setpoint, so as to avoid substituting one known objectionable setpoint for another. In other embodiments, however, the method 200 may not include checking to see if the adjusted setpoint is in the list of setpoints to avoid, because, in some embodiments, it may be assumed that the system harmonics are sufficiently far apart such that a small change in the operational setpoint is unlikely to result in the HVAC system 100 operating at close to or at another resonance frequency.

When the controller 128 determines that, at 208, the setpoint chosen is not in the list of setpoints to avoid, the controller 128 may proceed to signaling to the variable-speed components to operate according to the setpoint, thereby running the HVAC system 100, as at 212. At some point during operation of the HVAC system 100, the load may change. For example, during daytime hours, the ambient temperature may increase; thus, the variable-speed components in a heat pump configured to warm the volume of air 103 may be slowed. In another example, at various points during the day (e.g., shift changes in a commercial setting), the occupancy and/or frequency of ingress and egress of occupants may increase, which may also change the rate of heat transfer to/from the environment. Such load changes may result in a different temperature reading at the thermostat of the panel 126, which the panel 126 may transmit to the controller 128. The controller 128 may determine that a setpoint change is required to correct the temperature in the volume of air 103. However, in other embodiments, other indications of load change may be employed, such as outside temperature, humidity (inside or outside), frequency of doors opening, and/or the like.

Accordingly, the method 200 may proceed by the controller 128 detecting the occurrence of a load change, as at 214. The method 200 may thus loop back to determining a suitable setpoint, as at 206, based on information received by the controller 128 from the panel 126 and/or other sensors regarding the new load and/or the present conditions in or outside of the facility 102. The controller 128 may then proceed though setting the new setpoint and checking to ensure it is not in the list of setpoints to avoid, as described above, and may loop though this sequence multiple times to promote efficient operation of the variable-speed components of the HVAC system 100, at least.

As part of the method 200, the controller 128 may, at some point during running the HVAC system 100 at the setpoint, as at 212, receive a setpoint objection from the panel 126, as at 216. This setpoint objection may be manually registered by a user, for example, by the user pressing a button or actuating any other type of input device coupled to the panel 126. The setpoint objection may indicate that the running speed of one or more (e.g., a combination of) the variable-speed components (e.g., the compressor 108, fan 110, and/or blower 118) is provoking a high-amplitude vibration or response or noise in the HVAC system 100. As such, the threshold of the noise intensity or vibration amplitude deemed to be “excessive” or “high” may be user-defined based on the user's perceptions and tolerances, pitch, frequency of vibration, as well as background noise, such as air movement, or external environmental noises. For example, in some situations, a 70 dBA noise at a given pitch and under certain operating conditions may be found objectionable; however, in other situations, higher or lower intensity noise and/or vibration responses may be needed to provoke a setpoint objection. In other embodiments, the threshold of noise intensity or vibration amplitude required to provoke a setpoint objection may be predetermined, according to a selected level.

In response to receiving such an objection, the method 200 may proceed to adding the setpoint to the list of setpoints to avoid, as at 218. With this setpoint logged as being one to avoid, the HVAC system 100 may still need to be moved off the objectionable setpoint. Accordingly, the method 200 may include the controller 128 proceeding back to adjusting the setpoint, as at 210, and proceeding thereafter as already described.

In some embodiments, the controller 128 may be configured to automatically detect high-intensity responses, as at 220. For example, the controller 128 may detect noise and/or vibrations using the measuring devices 130, 132. The controller 128 may poll for data from the measuring devices 130, 132 at various intervals, and use the data received therefrom to determine whether the response intensity is above a threshold. In other embodiments, the measuring devices 130, 132 may be configured to transmit the data to the controller 128 when the response intensity is above the threshold (i.e., push data to the controller 128). In a further embodiment, the controller 128 may be configured to poll the measuring devices 130, 132 for data after a setpoint change (as at 206), to establish whether the new setpoint is one to avoid. Accordingly, if appropriate, the controller 128 may then proceed to adding the objectionable setpoint to the list of setpoints to avoid, and again proceed back to adjusting the setpoint away from the objectionable one and continuing operation of the HVAC system 100.

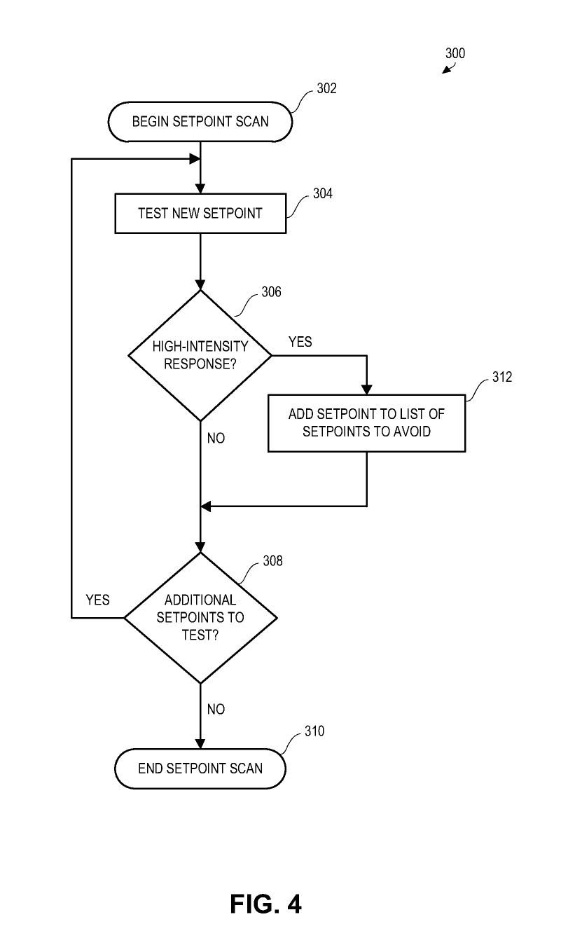

With continuing reference to FIGS. 1-3, FIG. 4 illustrates a flowchart of a method 300 for scanning the HVAC system 100 for objectionable setpoints, according to an embodiment. The method 300 may be performed as part of the method 200 (FIG. 3), for example, when scanning the system setpoints, as at 204, but in other embodiments, may be provided as a stand-alone process.

The method 300 may begin at 302, with the HVAC system 100 in place and prepared for startup. The method 300 may, however, be initiated at any suitable point of the life cycle of the HVAC system 100. For example, the method 300 may be run after installation and before normal operation, at some point after normal operation begins, at routine maintenance intervals, or the like.

The method 300 may proceed to picking a setpoint to test and testing that setpoint, as at 304. An initial value may be chosen for the testing at 304, which may be at a minimum speed or maximum speed of the moveable components of the HVAC system 100; however, the testing may begin at any setpoint. Subsequent setpoints may be chosen at a desired interval from the prior setpoint, with one or more variables changed by a specified amount so as to provide a desired granularity in the scanning results.

The HVAC system 100 may run at the selected setpoint, and the method 300 may include determining whether the setpoint results in a high-intensity response, as at 306. Such determination may proceed by querying a user as to whether excessive noise is perceived. The user may respond by pressing a button, or actuating another type of input device, e.g., on the panel 126, indicating that excessive noise is perceived. If no indication is returned (i.e., the inquiry is not answered) or an indication of noise being within acceptable levels is returned, the method 300 may continue to determining if there are additional setpoints to test, as at 308. Additionally or alternatively, the controller 128 may receive feedback from one or more of the measuring devices 130, 132, so as to automatically detect a high-intensity response generated at a given setpoint and, thereafter, proceed to determining whether additional setpoints are available for testing, as at 308. If such setpoints are available, the method 300 may include returning to testing and setting the next setpoint, as at 304. When the last setpoint test is completed, the method 300 may end, as at 310.

If, when the setpoint is being tested, excessive response intensity is detected or the setpoint is otherwise objected to, the method 300 may proceed to adding the objectionable setpoint to a list of setpoints to avoid, as at 312. The list of setpoints to avoid may be accessible for use in the HVAC system 100 during normal operation, so as to prevent known objectionable setpoints from being employed.

Further, the list of setpoints may be cleared at the onset of the method 300. Such clearing may be advantageous when employing the method 300 at intervals of operation of the HVAC system 100. The actual set of setpoints to avoid may evolve over time, as the HVAC system 100 structure may not be entirely static, but may be subject to small structural changes (e.g., expansion, joints loosening, etc.) that may change the vibration characteristics of the HVAC system 100. Accordingly, rather than keeping the old setpoints, which may be out of date, and adding to them with new setpoints to avoid, the method 300 may proceed to at least partially emptying the list of setpoints to avoid. In other embodiments, the old setpoints may be retained.

In another embodiment, the controller 128 may maintain two or more lists of setpoints to avoid. Referring back to FIG. 3, in an embodiment, the controller 128 may maintain a list of setpoints identified during the system scan, as at 204 (and/or the method 300), and a list of setpoints that were objected to by the user via the panel 126, as at 216, or detected as producing excessive vibrations, as at 220. Since the later of these lists may be more up to date, having been updated during use of the HVAC system 100, this list may be maintained. The former list, from the prior scan, may be emptied. In a further embodiment, the operator may determine which of the three lists to clear. In yet other embodiments, a single list may be kept of all the setpoints, and it may be cleared at the beginning of the method 300.

While the present teachings have been illustrated with respect to one or more implementations, alterations and/or modifications may be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings.

It will be appreciated that structural components and/or processing stages may be added or existing structural components and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein.

The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

Terms of relative position as used in this application are defined based on a plane parallel to the conventional plane or working surface of a workpiece, regardless of the orientation of the workpiece. The term “horizontal” or “lateral” as used in this application is defined as a plane parallel to the conventional plane or working surface of a workpiece, regardless of the orientation of the workpiece. The term “vertical” refers to a direction perpendicular to the horizontal. Terms such as “on,” “side,” “higher,” “lower,” “over,” “top,” and “under” are defined with respect to the conventional plane or working surface being on the top surface of the workpiece, regardless of the orientation of the workpiece.

What is claimed is:

1. A method for operating a HVAC system having one or more variable-speed components, the method comprising:
running the one or more variable-speed components at a first setpoint;
determining that the first setpoint generates a response having an intensity above a threshold, the response comprising a vibration, a noise, or a combination thereof;
logging the first setpoint into a list of setpoints to avoid; and
in response to determining that the first setpoint generates the response having the intensity above the threshold, adjusting the one or more variable-speed components to a second setpoint.

2. The method of claim 1, further comprising:
selecting a third setpoint for the one or more variable-speed components;
determining that the third setpoint is in the list of setpoints to avoid;
in response to determining that the third setpoint is in the list of setpoints to avoid, selecting a fourth setpoint by adjusting the third setpoint; and
running the one or more variable-speed components according to the fourth setpoint.

3. The method of claim 1, wherein determining that the first setpoint generates the response having the intensity above the threshold comprises receiving an objection registered by a user on a panel.

4. The method of claim 1, further comprising installing the HVAC system in the field prior to running the HVAC system at the first setpoint.

5. The method of claim 1, further comprising:
scanning a range of setpoints for the one or more variable-speed components;
determining that an objectionable setpoint in the range of setpoints being scanned generates a response having an intensity above the threshold; and
adding the objectionable setpoint to the list of setpoints to avoid.

6. The method of claim 5, wherein determining that the objectionable setpoint produces the response having the intensity above the threshold comprises receiving a setpoint objection from a panel actuated by a user.

7. The method of claim 1, wherein determining that the first setpoint generates the response having the intensity above the threshold comprises detecting the response of the HVAC system using a sound measuring device, a vibration measuring device, or both.

8. The method of claim 1, wherein the one or more variable-speed components comprises a compressor configured to compress a working fluid, wherein adjusting the one or more variable-speed components comprises modulating a speed of the compressor.

9. The method of claim 1, wherein the one or more variable-speed components comprises a fan, blower, or both configured to move air across one or more heat exchangers of the HVAC system, wherein adjusting the one or more variable-speed components comprises modulating a speed of the fan, blower, or both.

10. A control system for an HVAC system, comprising:
a panel comprising an input device configured to register a setpoint objection from a user, wherein in the HVAC system comprises one or more variable-speed components, the one or more variable-speed components being operable at a plurality of setpoints; and
a controller configured to communicate with the panel and at least one of the one or more variable-speed components, the controller being configured to receive an indication of the setpoint objection from the panel and, in response, adjust a speed of at least one of the one or more variable-speed components.

11. The control system of claim 10, wherein the controller comprises a storage device on which a list of setpoints to avoid is stored, wherein the controller is configured to compare a setpoint of the one or more variable-speed components with the list of setpoints to avoid to determine whether to adjust the setpoint.

12. The control system of claim 10, further comprising one or more measuring devices configured to detect vibration, noise, or both in the HVAC system, the one or more measuring devices being coupled to the controller and configured to communicate therewith.

13. The control system of claim 10, wherein the one or more variable-speed components comprises a compressor configured to compress a working fluid, the HVAC system comprising a heat pump, an air conditioner, or both.

14. The control system of claim 10, wherein the one or more variable-speed components comprises a fan, blower, or both configured to move air across one or more heat exchangers.

15. The control system of claim 10, wherein the HVAC system comprises a furnace.

16. A system, comprising:
a processing system comprising a processor; and
a memory system comprising one or more computer-readable media, wherein the one or more computer-readable media contain instructions that, when executed by the processing system, cause the system to perform operations comprising:
running the one or more variable-speed components at a first setpoint;
determining that the first setpoint generates a response having an intensity above a threshold, the response comprising a vibration, a noise, or a combination thereof;
logging the first setpoint into a list of setpoints to avoid; and
in response to determining that the first setpoint generates the response having the intensity above the threshold, adjusting the one or more variable-speed components to a second setpoint.

17. The system of claim 16, wherein determining that the first setpoint generates the response having the intensity above the threshold comprises receiving a setpoint objection from a panel, the setpoint objection being registered by a user.

18. The system of claim 16, wherein determining that the first setpoint generates the response having the intensity above the threshold comprises:
receiving data from one or more measuring devices configured to detect vibration, noise, or both in the HVAC system; and
comparing the data to the threshold, wherein the threshold is predetermined.

19. The system of claim 16, wherein the operations further comprise:
scanning a range of setpoints for the one or more variable-speed components;
determining that an objectionable setpoint in the range of setpoints being scanned produces the response having the intensity above the threshold in the HVAC system; and
adding the objectionable setpoint to the list of setpoints to avoid.

20. The system of claim 16, wherein the one or more variable-speed components comprises a compressor configured to compress a working fluid, a fan configured to move air across an evaporator, a blower configured to move air across a condenser, or a combination thereof, wherein adjusting the speed of the one or more variable-speed components comprises modulating a speed of at least one of the compressor, the fan, and the blower.
